(19) United States
(12) Patent Application Publication
(10) Pub. No.: US 2014/0266636 A1
(43) Pub. Date: Sep. 18, 2014

(54) Modular Professional Equipment Controlled by Mobile Device

(71) Applicant: CAO GROUP, INC., West Jordan, UT (US)

(72) Inventors: Robert K. Larsen, Sandy, UT (US); Richard B. Draper, Sandy, UT (US); Jack Nichols, American Fork, UT (US); Densen Cao, Sandy, UT (US)

(73) Assignee: CAO GROUP, INC., West Jordan, UT (US)

(21) Appl. No.: 13/841,539

(22) Filed: Mar. 15, 2013

(51) Int. Cl. G08C 19/16

(52) U.S. Cl. CPC G08C 19/16
USPC 340/12.5

(57) ABSTRACT

Example embodiments of the present invention provide a medical or dental device that is controlled by a mobile device. For example, the medical or dental device can be configured to wirelessly be controlled by a PDA, smartphone, tablet, netbook, ultrabook, and/or other similar mobile computing device. The mobile computing device can have an application that is programmed to communicate with the medical or dental device hardware and memory to control the function of the medical or dental device during use.

### TECHNICAL FIELD OF THE INVENTION

The present disclosure generally relates to various methods, devices, equipment and systems used to provide a medical or dental system controlled by a mobile device.

### BACKGROUND OF THE INVENTION

Many medical and dental devices exist that are controlled by computer units. However, conventional medical and dental equipment controlled by computers are usually built in a single unit. For example, the hardware, firmware, and software are integral to the equipment itself. Thus, conventional systems are usually bulky, less portable, and lack connectivity with other equipment and interfaces.

Accordingly, there is a need for improved devices, systems and methods for providing computerized controls to medical and dental devices.

### SUMMARY OF THE INVENTION

Example embodiments of the present invention provide a medical or dental device that is controlled by a mobile device. For example, the medical or dental device can be configured to wirelessly be controlled by a PDA, smartphone, tablet, netbook, ultrabook, and/or other similar mobile computing device. The mobile computing device can have an application that is programmed to communicate with the medical or dental device hardware and memory to control the function of the medical or dental device during use.

In one example embodiment, the present invention comprises a system having a base unit that can provide a medical or dental function. In addition, a mobile device can be wirelessly connected to the base unit. The mobile device can include memory operatively coupled to the mobile device. Furthermore, an application can be stored in the memory, the application capable of controlling in part the medical or dental function.

In another example embodiment, professional device can include a base unit having a first communications module. In addition, the professional device can include a mobile device having a second communications module, the second communications module capable of wireless communication with the first communication module. Moreover, the professional device can include a hand piece that provides a professional function coupled to the base unit, the second communications module in the mobile device capable of wirelessly communicating an activation signal to the first communications module to allow the base unit to activate the professional function provided by the hand piece.

In yet a further example embodiment, a method includes wirelessly pairing a base unit having a professional function with a mobile device. In addition, the method includes accessing an application on the mobile device and then selecting a setting for the professional function using the application. Moreover, the method can include activating the professional function with the selected setting.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical implementations of the invention and are not therefore to be considered to be limiting of its scope, the invention will be described and explained with additional specificity and detail through the use of the accompanying drawings.

FIG. 1A illustrates a perspective view of a professional device, including a base unit and a mobile device;

FIG. 1B illustrates a second perspective view of a professional device, including a base unit and a mobile device; and

FIG. 2 illustrates a schematic of an example embodiment of a base unit and a mobile device.

### DETAILED DESCRIPTION OF THE INVENTION

Example embodiments of the present invention provide a professional device (e.g., a medical or dental device) that is controlled by a mobile device. For example, the medical or dental device can be configured to wirelessly be controlled by a PDA, smartphone, tablet, netbook, ultrabook, and/or other similar mobile computing device. The mobile computing device can have an application that is programmed to communicate with the medical or dental device hardware and memory to control the function of the medical or dental device during use.

Example embodiments of the present invention provide several advantages over conventional systems and methods of making and using a medical or dental device. For example, FIG. 1A and FIG. 1B illustrate one example embodiment of a professional device 100. For purposes of this application, the professional device 100 can be any medical or dental device. Examples of medical or dental devices include, but are not limited to, lasers, electric hand tools, drills and/or any device that can benefit from computer-controlled functions. For example, FIG. 1A and FIG. 1B illustrate an example embodiment of the professional device that is a dental laser, and as such will be used to describe various features of the professional device 100. It is understood that similar principles and concepts as described with reference to the dental laser can be applied to various other medical and dental devices.

As illustrated in FIG. 1A and FIG. 1B, the professional device 100 can include a base unit 102 and a mobile unit 104. As illustrated in FIG. 1A and FIG. 1B, the mobile unit 104 can dock (e.g., charge and/or communicate through a hardwire interface) with the base unit 102. In addition, the mobile unit 104 can undock with the base unit 102 while remaining in control of the function of the base unit 102. For example, the mobile unit 104 can be physically separated from the base unit 102 and control the base unit 102 function though a wireless communications protocol, such as Bluetooth®. Other wireless protocols may be used to allow communication between the mobile device 104 and the base unit 102.

In one example embodiment, and as illustrated in FIG. 1A and FIG. 1B, the mobile device 104 can be a smart phone or smart device (e.g., an iPhone® or iTouch®). Other mobile or wireless devices can be used to as the mobile device 104. For example, iPads®, tablets, laptops, and other mobile wireless devices can be programed to communicate, and thus control, the functions of the base unit 102.

As the mobile device 104 has the purpose of controlling the base unit 102, the base unit 102 contains all the hardware and firmware needed to function as a professional device. For example, and as illustrated in FIG. 1A and FIG. 1B, the base unit 102 for the dental laser can include a laser module, fan, thermostat, communications module, memory, and a processor. Note that the base unit 102 may not include many controls directly on the unit. This is because the mobile device 104 controls the base unit 102.

In one example embodiment, the base unit 102 includes an emergency stop button 106. The emergency stop button 106 provides a quick and easy way for an operator to shut off the professional device 100 in case of an emergency. In addition to the emergency stop button 106, the base unit 102 can include a power button 108. The power button 108 can be used to power on the base unit 102 such that the base unit 102 can communicate with the mobile device 104 to allow the mobile device to further control the functions of the base unit 102. In alternative embodiments, the base unit 102 may not have any controls on the base unit 102, and instead be controlled exclusively through the mobile device 104. For example, the emergency stop control may be placed on the mobile device 104

Additionally, in one example, the base unit 102 can further include indicator lights 110. For example, the base unit 102 can include one or more indicator lights 110 that can indicate an operation or status of an operation to an operator. For example, indicator lights may indicate power, connectivity with the mobile device, a ready light, warning light, and/or equipment in use light (e.g., a laser firing indicator light). The base unit 102 can include additional indicator lights as a particular piece of equipment may require.

As illustrated in FIG. 1A and FIG. 1B, the base unit 102 can be coupled to a hand piece 112. For example, FIG. 1A and FIG. 1B illustrate that the hand piece 112 can be a laser hand piece configured to transmit laser energy. In particular, the hand piece 112 can be coupled to a cable 114, and the cable 114 can be coupled to a laser module such that when the laser module is activated, laser energy is transported through the hand piece 112. In alternative embodiments, and depending on the professional device 100, the hand piece can be a drill or other electrical/pneumatic piece of medical or dental equipment that is controlled by a motor or similar component within the base unit 102.

The hand piece 112 can be made of a magnetic material, and the base unit 102 can have magnets mounted under the cover of the base unit 102 such that the magnets can attract and hold in the place the hand piece 112. For example, and as illustrated in FIG. 1A and FIG. 1B, the magnets can be located on the top of the base unit 102 cover such that the hand piece 112 is secured to the base unit 112. In alternative embodiments, the magnets can be placed to mount the hand piece 112 in other locations on the base unit 102. In addition to the magnets, the base unit 102 may contain indentations at the location of the magnets such that the operator can easily place the hand piece 112 in the location of the magnets and secure the hand piece 112 to the base unit 102.

The hand piece 112 can be made of an inner piece and an outer shell that is removable to enable the outer shell to be removed and autoclaved for sanitizing purposes. For example, the outer shell can be screwed to a base portion of the hand piece 112 to secure the outer shell during use of the hand piece 112. After use, the outer shell can be unscrewed from the base portion and slid off of the inner piece completely, thus allowing the outer shell to be sanitized without harming the components of the hand piece 112.

As was briefly described above, the mobile device 104 can be removed from the base unit 102 during operation. Because the mobile device 104 can be removed, it leaves the base unit 102 as a fairly compact unit that can be mounted under a cabinet, table top, or other similar office furniture to take advantage of space can protect the base unit 102 from damage. This is an advantage over conventional systems that require bulkier designs, and therefore, have to be placed on counter tops and tables during use and during storage.

Because the base unit 102 can be mounted under a counter (e.g., under a dentist tool rack), the hand piece 112 of the professional device 100 can be configured and sized to be stored in the dentist's tool rack next to dental drills, vacuums, water dispensers, and other hand pieces. Therefore, with example embodiments of the present invention, a dentist can have a laser hand piece 112 conveniently stored in the same location as conventional dental tools. In particular, the base portion of the hand piece 112 can be configured to fit into a conventional dentist tool holder.

FIG. 2 illustrates a schematic view of the base unit 102 and the mobile device 104. As indicated in FIG. 2, the mobile device can include a communications module 115, memory 116, and a processor 118. The communications module 115 can be used to communicate with the base unit 102, as well as other networks or devices. The memory 116 can be used to store software, such as applications, that are used to control the base unit 102. And finally, the processor 118 can be used to execute instructions from software and inputs from a user interface.

In addition, FIG. 2 illustrates that the base unit 102 can include a communications module 120 used to communicate with the communications module 115 of the mobile device 104. In addition, the base unit can include a processor 124 that can execute instructions and signals received from the communications module 120. The processor can access memory 122 stored on the base unit 102. In addition, the base unit 102 can include a laser module 126 that is controlled by the processor. A temperature sensor 128, which can activate a fan 130 upon reaching a defined temperature, can monitor the temperature of the laser module 126.

As briefly described above, the mobile device 104 can include an application that is designed to control the functions of the base unit 102. In one example embodiment, the application can function as a key to the base unit 102. For example, when the application is closed on the mobile device 104, all functions of the base unit are locked. However, upon initiation of the application on the mobile device 104, the communications module 115 on the mobile device 104 connects and/or pairs with the communications module 120 on the base unit 102, which unlocks the functions on the base unit 102.

Similarly, when the application is launched on the mobile device 104, all other functionality or programming on the mobile device can be shut down or limited as a safety feature. For example, the applications can suspend mobile telephone service when the mobile device 104 is controlling the base unit 102. In other example embodiments, various functions and programs on the mobile device 104 are maintained and can be used or accessed while also controlling the base unit 102.

In one example embodiment, the application starts with an intro screen. The intro screen includes a password protection as another safety feature. Once the passcode is entered correctly, for example, the application starts a pairing process with the communications module 120 in the base unit 102.

The next screen in the application can be the operating screen. From the operating screen, an operator can select a power setting, aiming beam on/off, tip size, power mode and frequency, etc. If the professional device 100 is not a laser, the operating screen can display and allow a user to select controls and settings depending on the particular type of medical or dental device.

After the operator selects from various setting in the operating screen, the application can display a ready screen. The ready screen can display the settings selected to inform the operator of the selection. Also, upon entering the ready screen, a ready indicator light can show on the base unit 102. A foot pedal or other similar device may be used to then initiate the transmission of the laser energy. For example, a wireless foot pedal is used to turn the laser on or off.

In addition to the intro screen, the operating screen and the ready screen, the mobile device can contain other screens that represent various tools and settings. For example, the application can show a device status screen that shows the status of the mobile device 104, the base unit 102 and the foot pedal (not shown). For example, each of these units can be battery powered, and thus the status screen can indicate the battery level of the mobile device 104, the base unit 102 and/or the foot pedal.

In addition, the application can include a pre-sets screen that automatically sets the base unit to have setting designed for a particular application of the professional device 100. For example, in the event the professional device is a laser, the application can contain a preset screen that allows an operator to select a particular procedure from a list, and upon selecting the procedure, the mobile device communicates with the base unit 102 and the base unit sets the laser module 126 with the related power setting for the particular procedure.

Moreover, the application can have a utility screen that allows an operator to adjust the volume of various features on the professional device, change a password, or other similar utilities.

In addition, because the application is on a mobile device, the mobile device can be configured to communicate directly with customer support. For example, in the instance of a laser device, the operator may have a question about how to use the device. The operator may simply click on a link that takes the user to a live video chat with a customer representative, for example, through a program like Facetime®. Thus, a live video customer service feature can be included directly on the professional device 100. Additionally, the application can be configured to send an email, text, make a phone call, or other wise initiate any other type of electronic communication. In addition, instruction manuals and training videos can be stored right on board the mobile device 104. Moreover, the mobile device 104 can be configured to allow the operator to register the professional device 100 through a wireless communication connection with the mobile device 104 portion of the professional device.

In one example embodiment, all controls and data, except for the user interface, is stored on the base unit 102. For example the base unit 102 memory 122 can store last settings used, time used, reference tables, history, operating system and codes and passwords. Thus, the operator can make a selection on the mobile device 104, the mobile device 104 communications the selection to the base unit 102, the processor on the base unit 104 processes the selection and then controls the laser module 126 accordingly.

Because the mobile device 104 can be undocked from the base unit 102, the mobile device 104 can be paired with multiple devices. For example, the same mobile device 104 can be used to control a dental laser as well as a dental drill. Alternatively, or in addition to, the mobile device 104 can be carried by the operator from one room to the next, pairing with different base units 102 that are located in each room.

The mobile device 104 can also be used as a diagnostic tool to diagnose or trouble shoot the base unit. For example, the mobile device 104 can have a trouble shooting algorithm that can test the functionality of each component on the base unit 102. In addition, the mobile device 104 can have the capability to be controlled wirelessly form a customer support center such that a customer support center can run a diagnostic check on the unit remotely.

Finally, the mobile device 104 can be configured to capture the type of service for which the operator is using the professional device 100. In one embodiment, for example, the operator can check a particular service to be performed. The mobile device can then store and/or transmit the service. In one example, the mobile device can be connected to a billing software program such that the service is automatically added to a patient's bill after the service is selected. The service data can be used by the operator, or by the manufacturer of the device, as market data on what services are most popular with a particular device, operator, geographic area, etc.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system, comprising:
a base unit having a medical or dental function;
a mobile device wirelessly connected to the base unit;
memory operatively coupled to the mobile device;
an application stored in the memory, the application capable of controlling in part the medical or dental function.

2. The system recited in claim 1, the base unit further comprising a docking station for charging the mobile device.

3. The system recited in claim 2, further comprising: a hand piece coupled to the base unit, the hand piece providing the medical or dental function.

4. The system as recited in claim 3, further comprising: a cable coupled between the hand piece and the base unit.

5. The system as recited in claim 4, further comprising: an emergency stop button located on the base unit, the emergency stop button capable of stopping the medical or dental function upon being pressed.

6. The system as recited in claim 5, wherein the mobile device comprises a user interface.

7. The system as recited in claim 6, wherein the medical or dental function is a laser function.

8. The system as recited in claim 6, wherein the medical or dental function is a pneumatic function.

9. The system as recited in claim 6, wherein the base unit comprises an indicator light to indicate when the base unit is in wireless communication with the mobile device.

10. The system as recited in claim 6, wherein the user interface includes multiples screens, each screen having a different purpose.

11. The system as recited in claim 10, wherein the medical or dental function is activated by a foot pedal.

12. The system as recited in claim 11, wherein the foot pedal is in wireless communication with the base unit.

13. A professional device, comprising:
a base unit having a first communications module;
a mobile device having a second communications module, the second communications module capable of wireless communication with the first communication module; and
a hand piece that provides a professional function coupled to the base unit, the second communications module in the mobile device capable of wirelessly communicating an activation signal to the first communications module to allow the base unit to activate the professional function provided by the hand piece.

14. The professional device as recited in claim 13, wherein the second communications module is capable of connecting to a customer service network.

15. The professional device as recited in claim 14, the customer service network providing a video conference capability.

16. The professional device as recited in claim 15, the mobile device comprising memory to store training videos about the professional device.

17. The professional device as recited in claim 14, the customer service network providing a text feature.

18. A method, comprising:
wirelessly pairing a base unit having a professional function with a mobile device;
accessing an application on the mobile device;
selecting a setting for the professional function using the application; and
activating the professional function with the selected setting.

19. The method recited in claim 18, wherein the activating the professional function with the selected setting is done with a foot pedal.

20. The method recited in claim 19, wherein the professional function comprises transmitting laser energy.
